(19) United States
(12) Patent Application Publication
(10) Pub. No.: US 2020/0307568 A1
(43) Pub. Date: Oct. 1, 2020

(54) VEHICLE DRIVING SUPPORT SYSTEM

(71) Applicant: Mazda Motor Corporation, Hiroshima (JP)

(72) Inventor: Hideki TAKAHASHI, Hiroshima (JP)

(73) Assignee: Mazda Motor Corporation, Hiroshima (JP)

(21) Appl. No.: 16/819,181

(22) Filed: Mar. 16, 2020

(30) Foreign Application Priority Data
Mar. 29, 2019 (JP) 2019-065421

(51) Int. Cl. B60W 30/09; H04W 4/40; B60R 11/04; B62D 15/02

(52) U.S. Cl. CPC B60W 30/09; H04W 4/40; B60W 10/04; B62D 15/0265; B60R 11/04

(57) ABSTRACT

Provided is a vehicle driving support system that achieves a balance between accurately evaluating the path cost of a candidate path and reducing the load of calculating the path cost. A vehicle driving support system includes a controller that sets a target path on a travel road based on travel road information. The controller sets, in the vicinity of an obstacle, a warning area with an outer shape according to the obstacle, and sampling points at first intervals along a part of the candidate path that is included in the warning area, and sets the sampling points at second intervals, longer than the first interval, along the other part of the candidate path.

### CROSS-REFERENCE TO RELATED APPLICATION

The present application claims priority to JP 2019-065421, filed Mar. 29, 2019, the entire contents of which are incorporated herein by reference.

### BACKGROUND DISCLOSURE

### Field Disclosure

The present disclosure relates to a vehicle driving support system installed in a vehicle.

### Description of the Related Art

As algorithms used to set candidate paths of a vehicle (i.e., candidates that can be a target path for the vehicle to actually travel along), the method of potentials, spline interpolation functions, A-star (A*), RRT, and the state lattice method are known. Vehicle driving support systems using such algorithms have been proposed.

These algorithms allow a plurality of candidate paths to be set on a travel road of a vehicle. A path cost of each candidate path is calculated from the viewpoint of obstacle circumvention etc., and one candidate path determined as appropriate based on the calculation result is selected as a target path. For example, International Publication No. WO 2013/051081 discloses a vehicle driving support system that sets a plurality of candidate paths on a grid map and selects one candidate path based on a movement cost.

The system described in International Publication No. WO 2013/051081 calculates the movement cost at all those cells of a plurality of cells on the grid map that the candidate path passes through. While a technique of thus calculating a path cost at a large number of positions on a candidate path is rational from the viewpoint of enhancing the evaluation accuracy of the path cost of the candidate path, a heavy load of calculation is imposed on the system.

Especially when a technique like the state lattice method that can set a large number of candidate paths is used, a huge load of calculating the path cost may be imposed on the system. Therefore, a balance has been sought between reducing the load of calculation and accurately evaluating a path cost.

The present disclosure has been made to solve this problem, and an object thereof is to provide a vehicle driving support system that achieves a balance between accurately evaluating the path cost of a candidate path and reducing the load of calculating the path cost.

### SUMMARY DISCLOSURE

To solve the above problem, the present disclosure provides a vehicle driving support system installed in a vehicle. This system includes: a travel road information acquiring device that acquires travel road information relating to a travel road; an obstacle information acquiring device that acquires obstacle information relating to an obstacle on the travel road; and a controller that sets a target path on the travel road based on the travel road information and controls the vehicle so as to travel along the target path. The controller is configured to: set a plurality of candidate paths on the travel road based on the travel road information; set a plurality of sampling points at predetermined intervals along each of the plurality of candidate paths; calculate a path cost at each of the plurality of sampling points; and select one of the plurality of candidate paths as the target path based on the path cost. The controller is further configured to: set, in the vicinity of the obstacle, a warning area with an outer shape according to the obstacle; and set the sampling points at first intervals along a part of the candidate path that is included in the warning area, and set the sampling points at second intervals, longer than the first intervals, along the other part of the candidate path.

In this configuration, the controller sets, in the vicinity of an obstacle, a warning area with an outer shape according to the obstacle. Further, the controller sets the sampling points at the first intervals along a part of the candidate path that is included in the warning area. Since the first interval is shorter than the second interval, a plurality of sampling points are thus set at a relatively high density in the vicinity of the obstacle. As a result, the path cost in a range according to the obstacle can be evaluated with high accuracy.

On the other hand, for the other part of the candidate path (i.e., the part not included in the warning area), the controller sets the sampling points at the second intervals along this other part. Since the second interval is longer than the first interval, a plurality of sampling points are thus set at a relatively low density in the other part. As a result, the load of calculating the path cost in the other part can be reduced. While the relatively low density of the sampling points reduces the evaluation accuracy of the path cost in the other part, this evaluation accuracy has a relatively minor impact on traveling of the vehicle through the warning area.

Thus, the above configuration makes it possible to evaluate a path cost with accuracy sufficient for practical use while reducing the load of calculation. As a result, a balance is achieved between accurately evaluating the path cost of a candidate path and reducing the load of calculating the path cost.

According to the present disclosure, the controller may be configured to make the outer shape of the warning area larger as a distance from the vehicle to the obstacle is longer.

Generally, the accuracy of determining an obstacle decreases as the distance from a vehicle equipped with the vehicle driving support system to the obstacle increases. In the above configuration, the outer shape of the warning area is made larger as a distance from the vehicle to the obstacle is longer, which allows setting of a warning area with an outer shape according to the accuracy of determining an obstacle. As a result, it is possible to evaluate a path cost with accuracy sufficient for practical use while reducing the load of calculation.

It is not necessary to make the outer shape of the warning area continuously larger as the distance from the vehicle to the obstacle increases. For example, a form of the warning area in which the outer shape of the warning area becomes larger stepwise as the distance from the vehicle to the obstacle increases is also included in the scope of the present disclosure.

According to the present disclosure, the controller may be configured to make the outer shape of the warning area larger when the obstacle is a vehicle than when the obstacle is a pedestrian.

This configuration makes it possible to evaluate a path cost with high accuracy in a larger range when the obstacle is a vehicle than when the obstacle is a pedestrian. Thus, a path cost relative to a vehicle that is an obstacle with a relatively high moving speed can be evaluated with higher accuracy. As a result, it is possible to evaluate a path cost with accuracy sufficient for practical use while reducing the load of calculation.

According to the present disclosure, the controller may be configured to set the first interval shorter when the obstacle is a pedestrian than when the obstacle is a vehicle.

This configuration makes it possible to set a plurality of sampling points in the warning area at a higher density when the obstacle is a pedestrian than when the obstacle is a vehicle. Thus, a path cost relative to a pedestrian that is an obstacle with a relatively small outer shape can be evaluated with higher accuracy. As a result, it is possible to evaluate a path cost with accuracy sufficient for practical use while reducing the load of calculation.

According to the present disclosure, the controller may be configured to, when there are a plurality of obstacles on the travel road, set the warning area in the vicinity of an obstacle that is closest to the vehicle and set no warning area in the vicinity of the other obstacles.

In this configuration, a plurality of sampling points are set at a relatively high density in the vicinity of an obstacle that is closest to the vehicle. Thus, a path cost relative to an obstacle that requires most attention for safety can be evaluated with higher accuracy. As a result, it is possible to evaluate a path cost with accuracy sufficient for practical use while reducing the load of calculation.

According to the present disclosure, a vehicle driving support system can be provided that achieves a balance between accurately evaluating the path cost of a candidate path and reducing the load of calculating the path cost.

### BRIEF DESCRIPTION OF THE DRAWINGS

FIG. 1 is a configuration diagram of a vehicle driving support system according to an embodiment;

FIG. 2 is a view illustrating candidate paths and sampling points;

FIG. 3 is a view illustrating candidate paths and sampling points;

FIG. 4 is a flowchart showing calculations executed by the ECU of FIG. 1;

FIG. 5 is a view illustrating candidate paths and sampling points according to a first modification; and

FIG. 6 is a view illustrating candidate paths and sampling points according to a second modification.

FIG. 7 is a block diagram of a computer-based system on which embodiments of the present system may be implemented.

### DETAILED DESCRIPTION

An embodiment will be described below with reference to the accompanying drawings. To make the description easy to understand, the same components in the drawings are denoted by the same reference signs and repetition of the same description will be avoided.

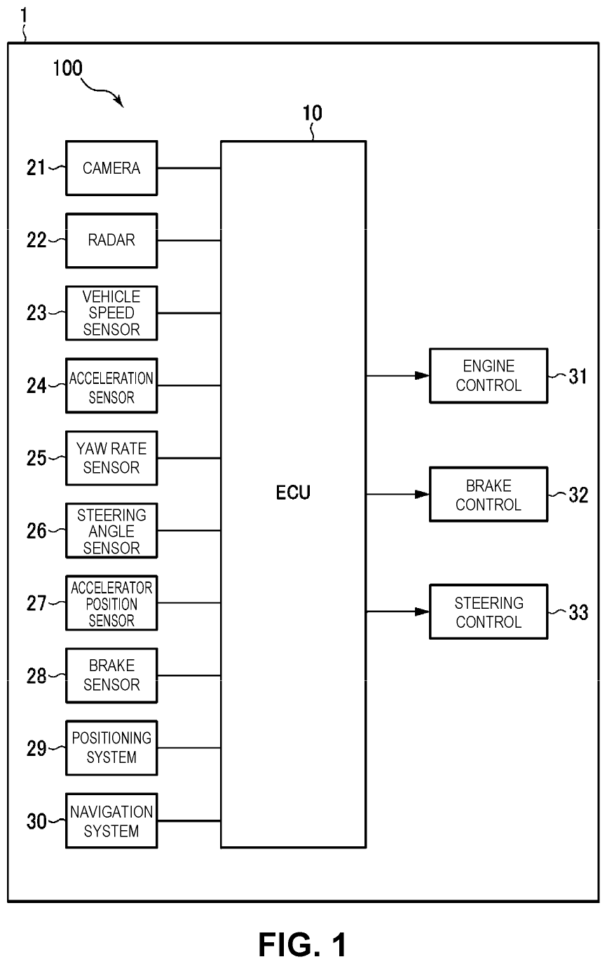

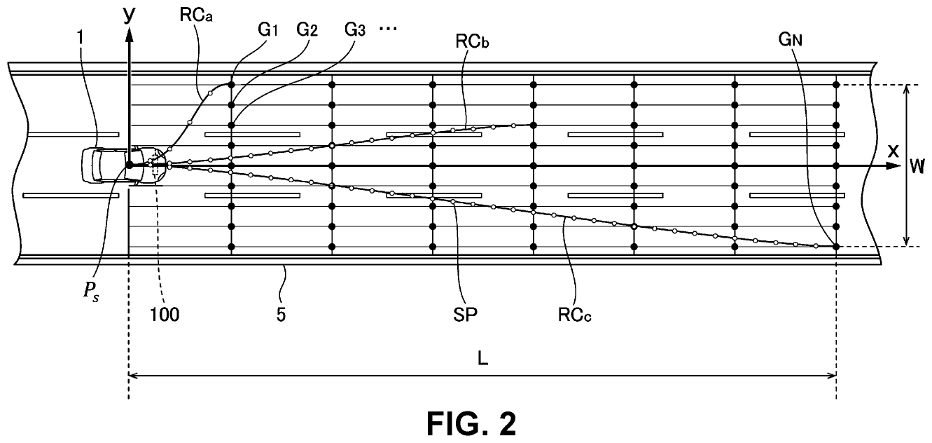

First, an overview of a vehicle driving support system 100 according to the present disclosure will be described with reference to FIG. 1 and FIG. 2. FIG. 1 is a configuration diagram of the vehicle driving support system 100. FIG. 2 is a view illustrating candidate paths RC and sampling points SP.

The vehicle driving support system 100 is installed in a vehicle 1 and provides driving support control under which the vehicle 1 travels along a target path. As shown in FIG. 1, the vehicle driving support system 100 includes an electronic control unit (ECU) 10, a plurality of sensors, and a plurality of control systems. The plurality of sensors include a camera 21 (having an image sensor that takes fixed and/or moving images in the visual spectrum and/or non-visual ranges such as infrared and ultraviolet), a radar and/or Lidar 22 (short-range radars, SRR, that operate, for example, in the 20 GHz to 27 GHz range, long range radars, LRR, operating, for example, in the 76 to 81 GHz range, as well as Lidar that operates in at least one of ultraviolet, visible, and near infrared spectrums using lasers having a principle wavelength, for example, in a range of 500 nm to 1000 nm), a vehicle speed sensor 23 that detects a behavior of the vehicle 1 and a driving operation by an occupant, an acceleration sensor 24, a yaw rate sensor 25, a steering angle sensor 26, an accelerator position sensor 27, and a brake sensor 28. The plurality of sensors further include a positioning system 29 that detects the position of the vehicle 1, and a navigation system 30. The plurality of control systems include an engine control system 31, a brake control system 32, and a steering control system 33.

As other sensors, a peripheral sonar that measures the distance and position of a structure around the vehicle 1 relative to the vehicle 1, a corner radar that measures an approach of a structure around the vehicle 1 at four corners of the vehicle 1, and an inner camera that takes images of the inside of the cabin of the vehicle 1, may be included.

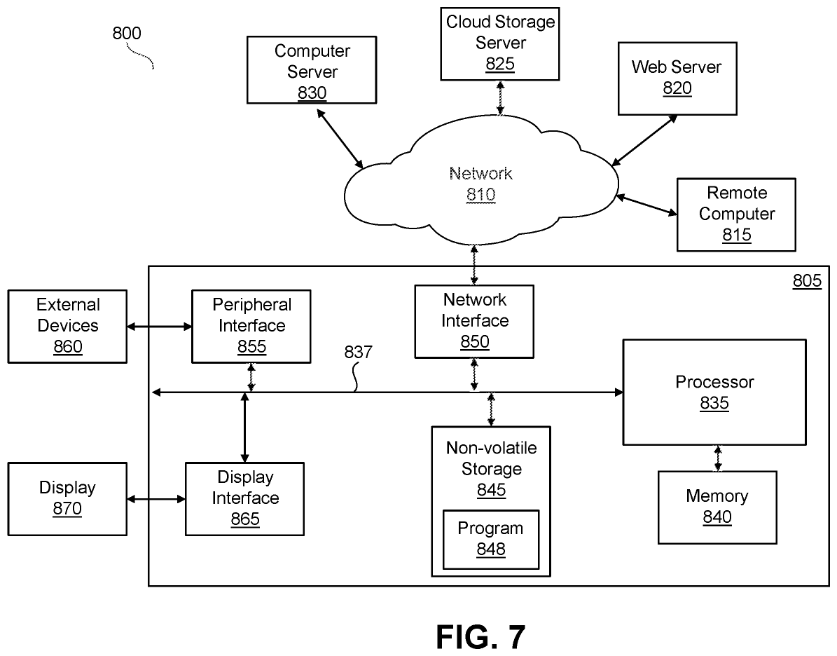

The ECU 10 is an example of the controller according to the present disclosure. The ECU 10 is formed by a computer including a CPU, a memory that stores various programs, an input-output device, and others. Optionally, the ECU may include the processor 835 and other circuitry in system 800 of FIG. 7, which may be implemented as a single processor-based system, or a distributed processor based system, including remote processing, such as cloud based processing. The ECU 10 executes various calculations based on signals received from the plurality of sensors, and sends control signals for appropriately operating an engine system, a brake system, and a steering system to the engine control system 31, the brake control system 32, and the steering control system 33, respectively.

The ECU 10 performs calculations to identify the position on a travel road based on travel road information. The travel road information is information relating to a travel road on which the vehicle 1 is traveling, and includes, for example, information relating to the shape of the travel road (straight, curved, the curvature of a curve), the width of the travel road, the number of lanes, the width of the lane, etc. The travel road information is acquired by the camera 21, the radar 22, the navigation system 30, etc.

FIG. 2 shows a state where the vehicle 1 is traveling on a travel road 5. By performing calculations based on the travel road information, the ECU 10 sets a plurality of imaginary grid points Gₙ (n=1, 2, . . . N) on the travel road 5 present in the traveling direction of the vehicle 1. When the extension direction of the travel road 5 is defined as an x-direction and the width direction of the travel road 5 is defined as a y-direction, the grid points Gₙ are arranged in a lattice pattern along the x-direction and the y-direction.

The range in which the ECU 10 sets the grid points Gₙ spans a distance L on a front side of the vehicle 1 along the travel road 5. The distance L is calculated based on the speed of the vehicle 1 at the time of execution of calculation. In this embodiment, the distance L is a distance that the vehicle 1 is expected to travel in a predetermined fixed time t (e.g., three seconds) at the speed (V) at the time of execution of calculation (L=V×t). However, the distance L may instead be a predetermined fixed distance (e.g., 100 m) or a function of the speed (and acceleration). A width W of the range in which the grid points Gₙ are set is set to substantially the same value as the width of the travel road 5. Setting such a plurality of grid points Gₙ allows identification of the position on the travel road 5.

Since the travel road 5 shown in FIG. 2 is a straight section, the grid points Gₙ are disposed in a rectangular pattern. However, as the grid points Gₙ are disposed along the extension direction of a travel road, when the travel road includes a curved section, the grid points Gₙ are disposed along the curve of the curved section. The road itself may be detected via visual discontinuities between the road surface and a different surface at the edge of the road, or by painted lines, reflectors, or other visual indicators on the road surface. Similar information is used for detecting a travel lane.

The ECU 10 executes calculations for setting candidate paths RC (i.e., candidates that can be a target path for the vehicle 1 to actually travel along) based on the travel road information and obstacle information. The obstacle information is information relating to whether there is any obstacle (e.g., a preceding vehicle, parked vehicle, pedestrian, dropped object, etc.) on the travel road 5 in the traveling direction of the vehicle 1, and to the type, size, moving direction, moving speed, etc. of that obstacle. The obstacle information is acquired by the camera 21 and/or the radar 22.

The ECU 10 sets a plurality of candidate paths RC by path search using the state lattice method. In the state lattice method, a plurality of candidate paths RC are set that extend, while branching off, from a start point Pₛ toward the grid points Gₙ present in the traveling direction of the vehicle 1. The start point Pₛ is the position of the vehicle 1 at the time of execution of calculation. In the example shown in FIG. 2, the vehicle 1 is located at the origin of the xy-coordinate system, and therefore the coordinate of the start point Pₛ is (0, 0). The ECU 10 specifies a multidimensional function with the x-coordinate being a variable relative to the y-coordinate, and sets, as the candidate paths RC, curves that are drawn in the xy-coordinate system based on the multidimensional function. This multidimensional function is, for example, a five-dimensional function or a three-dimensional function. FIG. 2 shows candidate paths RCₐ, RC_{b}, RC_{c} that are some of the plurality of candidate paths RC set by the ECU 10.

Further, the ECU 10 selects one candidate path RC with a minimum path cost from among the plurality of candidate paths RC. Specifically, as shown in FIG. 2, the ECU 10 first sets a plurality of sampling points SP along each candidate path RC. The plurality of sampling points SP are disposed at intervals on each candidate path RC. FIG. 2 shows, as an example, the sampling points SP that are set at regular intervals along the entire candidate paths RCₐ, RC_{b}, RC_{c}.

Next, the ECU 10 calculates a path cost at each sampling point SP. Further, for each candidate path RC, the ECU 10 adds up the path costs at the respective sampling points SP set along the candidate path RC, and divides the total value by the overall length of the candidate path RC. The ECU 10 uses a value obtained by this division as the path cost of that candidate path RC. The ECU 10 selects a candidate path RC with a minimum path cost from among the plurality of candidate paths RC, and sets this candidate path RC as a target path.

Moreover, the ECU 10 sets an amount of control for speed control and steering control of the vehicle 1 at each sampling point SP. This amount of control is set based on the speed and steering required to cause the vehicle 1 to travel along the target path, and is used also to calculate the path cost. Based on this amount of control, the ECU 10 sends control signals to the engine control system 31, the brake control system 32, and the steering control system 33.

The camera 21 is an example of the travel road information acquiring device as well as the obstacle information acquiring device according to the present disclosure. The camera 21 takes images of the surroundings of the vehicle 1 and outputs image data. Based on the image data received from the camera 21, the ECU 10 identifies an object (e.g., a preceding vehicle, parked vehicle, pedestrian, travel road, division line (lane line, white line, yellow line), traffic signal, traffic sign, stop line, intersection, etc.) When the object is a vehicle, the ECU 10 identifies the type of the vehicle (a large-size vehicle, a passenger vehicle, etc.). The ECU 10 may acquire information on an object from the outside by means of a transportation infrastructure, inter-vehicle communication, etc. Thus, the type, relative position, moving direction, etc. of the object are identified.

The radar 22 is an example of the travel road information acquiring device as well as the obstacle information acquiring device according to the present disclosure. The radar 22 measures the position and speed of an object (especially a preceding vehicle, parked vehicle, pedestrian, dropped object on the travel road 5, etc.). For example, a millimeter-wave radar can be used as the radar 22. The radar 22 transmits a radio wave in the traveling direction of the vehicle 1 and receives a reflected wave that is the transmitted wave reflected by an object. Based on the transmitted wave and the received wave, the radar 22 measures the distance between the vehicle 1 and the object (e.g., a vehicle-to-vehicle distance) and the speed of the object relative to the vehicle 1. In this embodiment, a laser radar, an ultrasonic sensor, or the like may be used instead of the radar 22 to measure the distance to an object and the relative speed of the object. A plurality of sensors may be used to form a position and speed measuring device.

The vehicle speed sensor 23 detects the absolute speed of the vehicle 1. The acceleration sensor 24 detects acceleration of the vehicle 1 (longitudinal acceleration and deceleration in a front-rear direction and lateral acceleration and deceleration in a lateral direction). The yaw rate sensor 25 detects a yaw rate of the vehicle 1. The steering angle sensor 26 detects a rotation angle (steering angle) of the steering wheel of the vehicle 1. The accelerator position sensor 27 detects the amount of depression of the accelerator pedal. The brake sensor 28 detects the amount of depression of the brake pedal.

The positioning system 29 is a GPS system and/or a gyro system, and detects the position of the vehicle 1 (current vehicle position information). The navigation system 30 has map information stored inside, and can provide the map information to the ECU 10. Based on the map information and the current vehicle position information, the ECU 10 identifies a road, intersection, traffic signal, building, etc. present around the vehicle 1 (especially in the traveling direction). The map information may instead be stored inside the ECU 10.

The engine control system 31 controls the engine of the vehicle 1. When it is necessary to accelerate or decelerate the vehicle 1, the ECU 10 sends a control signal to the engine control system 31 to change the engine output.

The brake control system 32 controls the brake device of the vehicle 1. When it is necessary to decelerate the vehicle 1, the ECU 10 sends a control signal to the brake control system 32 to generate braking force.

The steering control system 33 controls the steering device of the vehicle 1. When it is necessary to change the traveling direction of the vehicle 1, the ECU 10 sends a control signal to the steering control system 33 to change the steering direction.

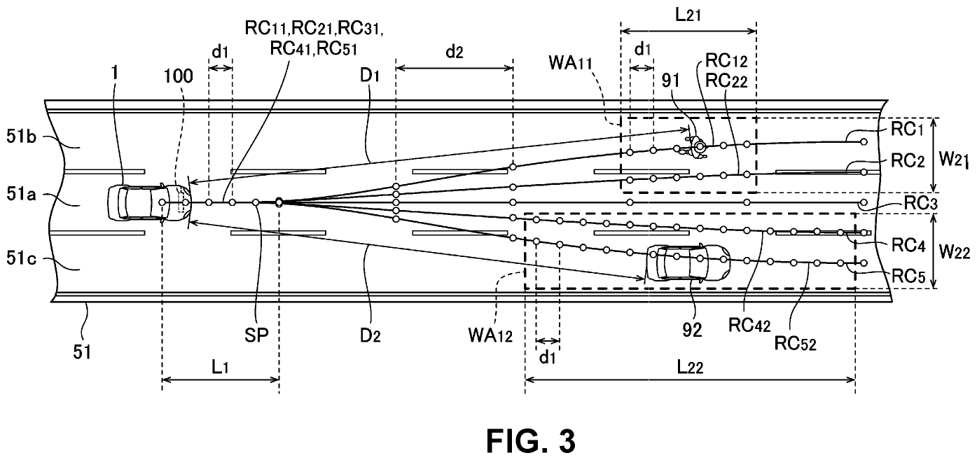

Next, calculations for setting the sampling points SP will be described with reference to FIG. 3. FIG. 3 is a view illustrating the candidate paths RC and the sampling points SP.

As described above, the ECU 10 sets a plurality of sampling points SP along each candidate path RC. While setting a larger number of the sampling points SP can increase the evaluation accuracy of the path cost of each candidate path RC, a larger load of calculation is imposed on the system, which impairs its practicality. Therefore, to achieve a balance between accurately evaluating a path cost and reducing the load of calculation, the ECU 10 sets the sampling points SP based on a warning area WA. In the following, a method of setting the sampling points SP will be described.

FIG. 3 shows the candidate paths RC and the sampling points SP in the case where the vehicle 1 is traveling in a lane 51a of a travel road 51. A pedestrian 91 is located in a lane 51b on the left of the lane 51a and another vehicle 92 is located in a lane 51c on the right of the lane 51a.

By the above-described path search using the state lattice method, candidate paths RC₁ to RC₅ are set on the travel road 51.

The ECU 10 sets a warning area WA₁₁ on the travel road 5. The warning area WA₁₁ is an imaginary area including the pedestrian 91. Specifically, the warning area WA₁ has a rectangular shape with a length L₂₁ (e.g., 15 m) in the x-direction (see FIG. 2) and a length W₂₁ (e.g., 5 m) in the y-direction (see FIG. 2). The ECU 10 sets the lengths L₂₁, W₂₁ larger as a distance D₁ from the vehicle 1 to the pedestrian 91 is longer. In the example shown in FIG. 3, the warning area WA₁₁ includes a part of each of the candidate paths RC₁, RC₂.

The ECU 10 further sets a warning area WA₁₂ on the travel road 5. The warning area WA₁₂ is an imaginary area including the vehicle 92. Specifically, the warning area WA₁₂ has a rectangular shape with a length L₂₂ (e.g., 30 m) in the x-direction and a length W₂₂ (e.g., 10 m) in the y-direction (see FIG. 2). The ECU 10 sets the lengths L₂₂, W₂₂ larger as a distance D₂ from the vehicle 1 to the vehicle 92 is longer. In the example shown in FIG. 3, the warning area WA₁₂ includes a part of each of the candidate paths RC₄, RC₅.

The ECU 10 sets the sampling points SP at intervals of d₁ along a part of each of the candidate paths RC₁, RC₂, RC₄, RC₅ that is in the vicinity of the vehicle 1. The interval d₁ is an example of the first interval according to the present disclosure. Specifically, the ECU 10 sets the sampling points SP at intervals of d₁ along first parts RC₁₁, RC₂₁, RC₄₁, RC₅₁ of the candidate paths RC₁, RC₂, RC₄, RC₅. The first parts RC₁₁, RC₂₁, RC₄₁, RC₅₁ span a length L₁ (e.g., 10 m) in the x-direction from the vehicle 1. The ECU 10 sets the length L₁ larger as the moving speed of the vehicle 1 is higher.

The ECU 10 sets the sampling points SP at intervals of d₁ along a part of each of the candidate paths RC₁, RC₂ that is relatively close to the pedestrian 91. Specifically, the ECU 10 sets the sampling points SP at intervals of d₁ along second parts RC₁₂, RC₂₂ of the candidate paths RC₁, RC₂ that are included in the warning area WA₁₁.

The ECU 10 further sets the sampling points SP at intervals of d₁ along a part of each of the candidate paths RC₄, RC₅ that is relatively close to the vehicle 92. Specifically, the ECU 10 sets the sampling points SP at intervals of d₁ along second parts RC₄₂, RC₅₂ of the candidate paths RC₄, RC₅ that are included in the warning area WA₁₂.

Moreover, the ECU 10 sets the sampling points SP at intervals of d₂ along parts of the candidate paths RC₁, RC₂, RC₄, RC₅ other than the first parts RC₁₁, RC₂₁, RC₄₁, RC₅₁ and the second parts RC₁₂, RC₂₂, RC₄₂, RC₅₂. The interval d₂ is an example of the second interval according to the present disclosure.

The interval d₂ is longer than the interval d₁ (e.g., d₁=0.2 m, d₂=2.0 m). Therefore, the sampling points SP are set at a relatively high density along the first parts RC₁₁, RC₂₁, RC₄₁, RC₅₁ and the second parts RC₁₂, RC₂₂, RC₄₂, RC₅₂, while the sampling points SP are set at a relatively low density along the other parts. In other words, the number of the sampling points SP per unit length in the first parts RC₁₁, RC₂₁, RC₄₁, RC₅₁ and the second parts RC₁₂, RC₂₂, RC₄₂, RC₅₂ is larger than that in the other parts. In parts of the candidate paths RC₁, RC₂, RC₄, RC₅ that are located between the vehicle 1 and the warning areas WA₁₁, WA₁₂, the setting interval of the sampling points SP becomes longer from d₁ to d₂ as the sampling points SP are set farther away from the vehicle 1 in the traveling direction of the vehicle 1.

On the other hand, for the candidate path RC₃ that is not included in either of the warning areas WA₁₁, WA₁₂, the ECU 10 sets the sampling points SP at intervals of d₁ in a first part RC₃₁ that spans the length L₁ in the x-direction from the vehicle 1, and sets the sampling points SP at intervals of d₂ at the other part.

As can be understood from FIG. 3, the ECU 10 sets the sampling points SP preferentially in the vicinity of the pedestrian 91 or the vehicle 92 and in the vicinity of the vehicle 1. In other words, the ECU 10 reduces the density of the sampling points SP in the part of the candidate path RC other than both of the part in the vicinity of the pedestrian 91 or the vehicle 92 and the part in the vicinity of the vehicle 1. This makes it possible to evaluate the path cost in the vicinity of the pedestrian 91 or the vehicle 92 and in the vicinity of the vehicle 1 with high accuracy, and at the same time reduce the load of calculating the path cost in the other parts. Thus, a balance is achieved between reducing the load of calculation and accurately evaluating a path cost.

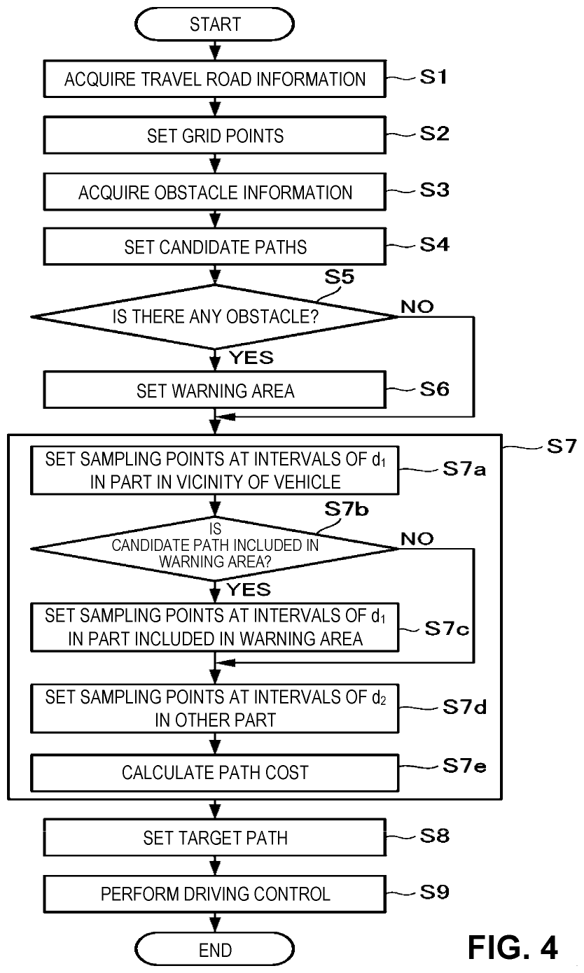

Next, calculations that the ECU 10 executes when providing driving support control will be described with reference to FIG. 4. FIG. 4 is a flowchart showing the calculations executed by the ECU 10. The ECU 10 repeatedly executes the calculations shown in FIG. 4 (e.g., once every 0.05 to 0.2 seconds).

First, in step S1, the ECU 10 acquires the travel road information from the camera 21, the radar 22, and the navigation system 30 (see FIG. 1). Alternatively, or complimentarily, the travel road information may be obtained from other sources as well, such as Lidar, and from radio frequency (RF) communication messages received by a RF receiver and the RF messages sent from external devices such as other cars, which have other sensors, as well as beacons, which are local devices that transmit absolute position data of SPs on the travel road in that particular location.

Next, in step S2, the ECU 10 identifies the shape of the travel road (e.g., the extension direction of the travel road, the width of the travel road, etc.) based on the travel road information, and sets a plurality of grid points Gₙ (n=1, 2, . . . N) on the travel road. For example, the ECU 10 sets grid points Gₙ at 10 m intervals in the x-direction (see FIG. 2) and at 0.875 m intervals in the y-direction (see FIG. 2).

Next, in step S3, the ECU 10 acquires the obstacle information from the camera 21 and the radar 22. Specifically, the ECU 10 acquires information relating to whether there is any obstacle on the travel road in the traveling direction of the vehicle 1, the type of obstacle, the moving direction and moving speed of the obstacle, etc. Alternatively, or complimentarily, the obstacle information may be obtained from other sources as well, such as Lidar, and from radio frequency (RF) communication messages received by a RF receiver and the RF messages sent from external devices such as other cars, which have other sensors, as well as beacons, which are local devices that transmit absolute position data of SPs on the travel road in that particular location

Next, in step S4, the ECU 10 sets a plurality of candidate paths RC on the travel road. Specifically, the ECU 10 specifies curved lines extending from the start point Pₛ (see FIG. 2) that is the position of the vehicle 1 at the time of execution of calculation, to the grid points Gₙ set in step S2, and sets these curved lines as the candidate paths RC. Moreover, lattice-based graphs are constructed by applying a set of motion primitives to each state expanded during the search in order to generate valid successor states. By doing this, they generate edges in the search graph between the (possibly non-adjacent) discretized states which serve as the graph nodes. A graph search algorithm, such as A* act on this lattice to generate a trajectory as a sequence of motion primitives between the start and goal state. As a type of graph, a state lattice has a set of states, S, connected by edges, E. To construct the set of states, S, each dimension is discretized into cells of finite size. Typically, metric dimensions are divided into small grids, for example, 0.1 m square regions, or as angular dimensions, e.g. {0°, 45°, . . . , 315°}. Larger cells, and therefore fewer states, improvs planning speed, while smaller cells can more accurately represent the environment but require more processing power. State lattices for vehicle movement also may include curvature, velocity, or other state variables as well. An example set is (x, y, yaw, vel). Edges of the state lattice are constructed by applying a set of pre-computed motion primitives to each state s∈S and then adding a directed edge from s to the state s′∈S at which the motion primitive ends. The motion primitives can be generated in a number of different ways. Example motion primitives are optionally generated off-line and stored as a library or via a control signal applied for a short time, where the trajectory resulting from this control input is the motion primitive. In an exemplary embodiment, motion primitives for stored in advance for left and right hand lane changes.

Next, in step S5, the ECU 10 determines whether there is any obstacle in the traveling direction of the vehicle 1 based on the obstacle information. When it is determined that there is an obstacle in the traveling direction of the vehicle 1 (S5: YES), the ECU 10 moves to step S6.

Next, in step S6, the ECU 10 sets a warning area WA on the travel road 5. As described above, when the obstacle is a pedestrian, the ECU 10 sets the warning area WA including the pedestrian. When the obstacle is a vehicle, the ECU 10 sets the warning area WA including the vehicle. The ECU 10 makes the outer shape of the warning area WA larger as the distance from the vehicle 1 to the obstacle is longer.

When the obstacle is a vehicle, the ECU 10 may make the outer shape of the warning area WA larger according to the type of the vehicle. For example, the ECU 10 may make the outer shape of the warning area WA larger when the obstacle is a large-size vehicle, such as a freight vehicle or a bus, than when the obstacle is a passenger vehicle. After setting the warning area WA in step S6, the ECU 10 moves to step S7.

On the other hand, when it is determined in step S5 that there is no obstacle in the traveling direction of the vehicle 1 (S5: NO), the ECU 10 moves to step S7 without going through step S6. Thus, the ECU 10 moves to step S7 without setting the warning area WA.

Step S7 includes setting of the sampling points SP (steps S7a to S7d) and calculation of the path cost (step S7e).

In step S7a, the ECU 10 sets the sampling points SP at intervals of d₁ along a part of the candidate path RC that is in the vicinity of the vehicle 1. Here, the sampling points SP are set along a part of the candidate path RC that spans the length L₁ in the x-direction (see FIG. 2) from the vehicle 1 (see FIG. 3).

Next, in step S7b, the ECU 10 determines whether or not the candidate path RC is included in the warning area WA. When it is determined that the candidate path RC is included in the warning area WA (S7b: YES), the ECU 10 moves to step S7c.

Next, in step S7c, the ECU 10 sets the sampling points SP at intervals of d₁ along a part of the candidate path RC that is included in the warning area WA.

Next, in step S7d, the ECU 10 sets the sampling points SP at intervals of d₂ along the other part of the candidate path RC (i.e., the part other than both of the part included in the warning area WA and the part in the vicinity of the vehicle 1).

On the other hand, when it is determined in step S7b that the candidate path RC is not included in the warning area WA (S7b: NO), the ECU 10 moves to step S7d without going through step S7c. Also when the ECU 10 has determined in step S5 that there is no obstacle in the traveling direction of the vehicle 1 (S5: NO) and therefore has not set the warning area WA, the ECU 10 determines that the candidate path RC is not included in the warning area WA (S7b: NO), and moves to step S7d without going through step S7c.

When the candidate path RC is not included in the warning area WA (S7b: NO), in step S7d, the ECU 10 sets the sampling points SP at intervals of d₂ along the other part of the candidate path RC (i.e., the part other than the part in the vicinity of the vehicle 1). The range in which the sampling points SP are set at intervals of d₂ in this case is larger than that when the candidate path RC is included in the warning area WA (S7b: YES). In other words, the number of the set sampling points SP is smaller when the candidate path RC is not included in the warning area WA than when the candidate path RC is included in the warning area WA.

Next, in step S7e, the ECU 10 calculates a path cost at each sampling point SP in the candidate path RC. The path cost includes a cost relating to the speed, acceleration, lateral acceleration, a rate of change of the path, obstacle, etc. These costs can be set as appropriate. As a general idea, a path cost includes a movement cost and a safety cost. For example, when the vehicle travels along a straight path, the moving distance is shorter and therefore the movement cost is lower, whereas when the vehicle travels along a path that circumvents an obstacle etc., the moving distance is longer and therefore the movement cost is higher. The movement cost increases as the lateral acceleration increases. As described above, the ECU 10 stores a value obtained by division in the memory (not shown) as the path cost of the candidate path RC.

The ECU 10 executes these calculations in step S7 for each of the plurality of candidate paths RC set in step S4.

Next, in step S8, the ECU 10 sets a target path. Specifically, the ECU 10 selects a candidate path RC with a minimum path cost, and sets this candidate path RC as a target path.

Next, in step S9, the ECU 10 sends control signals to the engine control system 31, the brake control system 32, and the steering control system 33 such that the vehicle 1 travels along the target path. These control signals are generated based on the amount of control for speed control and steering control of the vehicle 1 that is set at each sampling point SP in the target path.

In the following, effects of the vehicle driving support system 100 of this embodiment will be described.

In the above-described configuration, the ECU 10 that is the controller sets, in the vicinity of an obstacle, the warning area WA with an outer shape according to the obstacle. Further, the ECU 10 sets the sampling points SP at intervals of d₁ along a part of the candidate path RC that is included in the warning area WA. Since the interval d₁ is shorter than the interval d₂, a plurality of sampling points SP are thus set at a relatively high density in the vicinity of the obstacle. As a result, the path cost in the range according to the obstacle can be evaluated with high accuracy.

The dimension of the warning area WA in the front-rear direction may be made larger, for example, when, based on image data received from the camera 21, the obstacle is a vehicle and this vehicle is assumed to be a truck from the height and width of the vehicle, than when the vehicle is a passenger vehicle. A table showing types of vehicle and corresponding sizes of the warning area may be stored in the ECU 10 in advance, and the ECU 10 may set the dimension of the warning area WA according to the type of vehicle by referring to this table.

On the other hand, for the other part of the candidate path RC (i.e., the part not included in the warning area WA), the ECU 10 sets the sampling points SP at intervals of d₂ along this other part. Since the interval d₂ is longer than the interval d₁, a plurality of sampling points SP are thus set at a relatively low density in the other part. As a result, the load of calculating the path cost in the other part can be reduced. While the relatively low density of the sampling points SP reduces the evaluation accuracy of the path cost in the other part, this evaluation accuracy has a relatively minor impact on traveling of the vehicle 1 through the warning area WA.

Thus, the above configuration makes it possible to evaluate a path cost with accuracy sufficient for practical use while reducing the load of calculation. As a result, a balance is achieved between accurately evaluating the path cost of the candidate path RC and reducing the load of calculating the path cost.

The ECU 10 is configured to make the outer shape of the warning area WA larger as the distance from the vehicle 1 to the obstacle is longer.

Generally, the accuracy of determining an obstacle decreases as the distance from the vehicle 1 equipped with the vehicle driving support system 100 to the obstacle increases. In the above configuration, the outer shape of the warning area WA is made larger as the distance from the vehicle 1 to the obstacle is longer, which makes it possible to set the warning area WA with an outer shape according to the accuracy of determining an obstacle. As a result, it is possible to evaluate a path cost with accuracy sufficient for practical use while reducing the load of calculation.

The ECU 10 is further configured to make the outer shape of the warning area WA larger when the obstacle is a vehicle than when the obstacle is a pedestrian.

In this configuration, a path cost can be evaluated with high accuracy in a larger range when the obstacle is a vehicle than when the obstacle is a pedestrian. In other words, a path cost relative to a vehicle that is an obstacle with a relatively high moving speed can be evaluated with higher accuracy. As a result, it is possible to evaluate a path cost with accuracy sufficient for practical use while reducing the load of calculation.

Alternatively, a plurality of sampling points SP may be set such that the density of the sampling points SP inside the warning area WA becomes gradually higher from an end to a central part of the warning area WA. This makes it possible to reduce the load of calculation while increasing the evaluation accuracy of the path cost at the central part of the warning area WA at which the obstacle is highly likely to be present.

First Modification

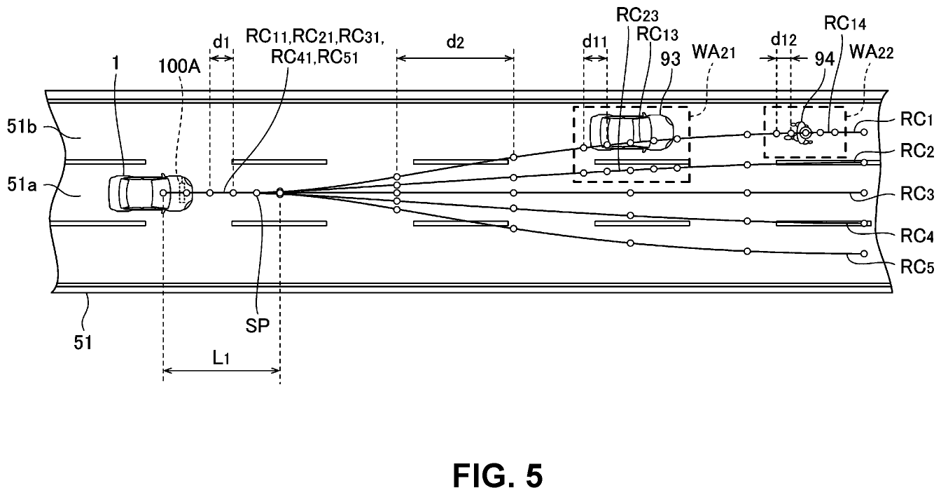

Next, a vehicle driving support system 100A according to a first modification will be described with reference to FIG. 5. FIG. 5 is a view illustrating candidate paths RC and sampling points SP according to the first modification.

Like the vehicle driving support system 100 of the embodiment, the vehicle driving support system 100A is installed in the vehicle 1 and provides driving support control under which the vehicle 1 travels along a target path. The vehicle driving support system 100A differs from the system of the embodiment in the method of setting the sampling points SP etc. Description of features that the vehicle driving support system 100A has in common with the system of the embodiment will be omitted as appropriate.

FIG. 5 shows the candidate paths RC and the sampling points SP in the case where the vehicle 1 is traveling in the lane 51a of the travel road 51. Another vehicle 93 and a pedestrian 94 are located in the lane 51b on the left of the lane 51a.

The controller of the vehicle driving support system 100A sets warning areas WA₂₁, WA₂₂ on the travel road 51. The warning area WA₂₁ includes the vehicle 93, and the warning area WA₂₂ includes the pedestrian 94. In the example shown in FIG. 5, the warning area WA₂₁ includes a part of each of candidate paths RC₁, RC₂, and the warning area WA₂₂ includes a part of the candidate path RC₁.

The controller sets the sampling points SP at intervals of d₁ along a part of each of the candidate paths RC₁, RC₂ that is in the vicinity of the vehicle 1. Specifically, the controller sets the sampling points SP at intervals of d₁ along first parts RC₁₁, RC₂₁ of the candidate paths RC₁, RC₂.

The controller sets the sampling points SP at intervals of d₁₁ along third parts RC₁₃, RC₂₃ of the candidate paths RC₁, RC₂ that are included in the warning area WA₂₁. The interval d₁₁ is an example of the first interval according to the present disclosure. In the first modification, the interval d₁₁ is set to the same value as the distance d₁ (e.g., d₁ =d₁=0.2 m).

The controller further sets the sampling points SP at intervals of d₁₂ along a fourth part RC₁₄ of the candidate path RC₁ that is included in the warning area WA₂₂. The interval d₁₂ is an example of the first interval according to the present disclosure.

The interval d₁₂ is shorter than the interval d₁₁ (e.g., d₁₂=0.1 m). Therefore, the density of the sampling points SP set along the fourth part RC₁₄ is higher than the density of the sampling points SP set along the third parts RC₁₃, RC₂₃. In other words, the number of the sampling points SP per unit length in the fourth part RC₁₄ is larger than that in the third parts RC₁₃, RC₂₃.

On the other hand, for candidate paths RC₃ to RC₅ that are not included in either of the warning areas WA₂₁, WA₂₂, the controller sets the sampling points SP at intervals of d₁ in first parts RC₃₁, RC₄₁, RC₅₁ that span the length L₁ in the x-direction from the vehicle 1, and sets the sampling points SP at intervals of d₂ in the other parts.

Thus, the controller of the vehicle driving support system 100A according to the first modification is configured to set the first interval shorter when the obstacle is a pedestrian than when the obstacle is a vehicle.

This configuration makes it possible to set a plurality of sampling points SP at a higher density in the warning area WA when the obstacle is a pedestrian than when the obstacle is a vehicle. Thus, a path cost relative to a pedestrian that is an obstacle with a relatively small outer shape can be evaluated with higher accuracy. As a result, it is possible to evaluate a path cost with accuracy sufficient for practical use while reducing the load of calculation.

Second Modification

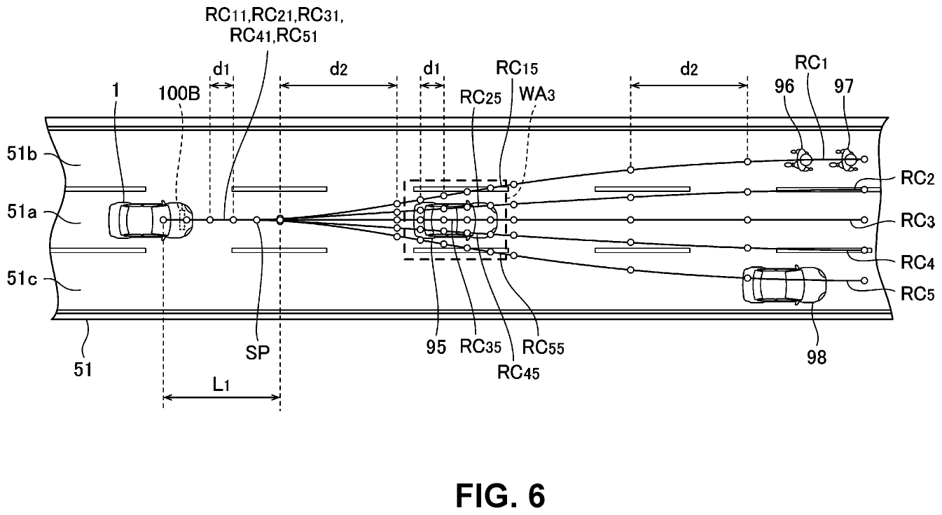

Next, a vehicle driving support system 100B according to a second modification will be described with reference to FIG. 6. FIG. 6 is a view illustrating candidate paths RC and sampling points SP according to the second modification.

Like the vehicle driving support system 100 of the embodiment, the vehicle driving support system 100B is installed in the vehicle 1 and provides driving support control under which the vehicle 1 travels along a target path. The vehicle driving support system 100B differs from the system of the embodiment in the method of setting the sampling points SP etc. Description of features that the vehicle driving support system 100B has in common with the system of the embodiment will be omitted as appropriate.

FIG. 6 shows the candidate paths RC and the sampling points SP in the case where the vehicle 1 is traveling in the lane 51a of the travel road 51. Another vehicle 95 is located in the lane 51a. Pedestrians 96, 97 are located in the lane 51b on the left of the lane 51a and another vehicle 98 is located in the lane 51c on the right of the lane 51a.

The controller of the vehicle driving support system 100B sets a warning area WA₃ on the travel road 51. The warning area WA₃ includes the vehicle 95 that is an obstacle closest to the vehicle 1. In the example shown in FIG. 6, the warning area WA₃ includes a part of each of candidate paths RC₁ to RC₅.

The controller sets the sampling points SP at intervals of d₁ along a part of each of the candidate paths RC₁ to RC₅ that is in the vicinity of the vehicle 1. Specifically, the controller sets the sampling points SP at intervals of d₁ along first parts RC₁₁, RC₂₁, RC₃₁, RC₄₁, RC₅₁ of the candidate paths RC₁ to RC₅.

On the other hand, the controller does not set the warning area WA in the vicinity of the pedestrians 96, 97 and the vehicle 98 that are obstacles present farther away from the vehicle 1 than the vehicle 95 is.

Thus, the controller of the vehicle driving support system 100B according to the second modification is configured to, when there are a plurality of obstacles on the travel road, set the warning area WA in the vicinity of an obstacle that is closest to the vehicle 1 and set no warning area WA in the vicinity of the other obstacles.

In this configuration, a plurality of sampling points SP are set at a relatively high density in the vicinity of an obstacle that is closest to the vehicle 1. Thus, a path cost relative to an obstacle that requires most attention for safety can be evaluated with higher accuracy. As a result, it is possible to evaluate a path cost with accuracy sufficient for practical use while reducing the load of calculation.

FIG. 7 illustrates a block diagram of a computer that may implement the various embodiments described herein.

The present disclosure may be embodied as a system, a method, and/or a computer program product. The computer program product may include a computer readable storage medium on which computer readable program instructions are recorded that may cause one or more processors to carry out aspects of the embodiment.

The computer readable storage medium may be a tangible device that can store instructions for use by an instruction execution device (processor). The computer readable storage medium may be, for example, but is not limited to, an electronic storage device, a magnetic storage device, an optical storage device, an electromagnetic storage device, a semiconductor storage device, or any appropriate combination of these devices. A non-exhaustive list of more specific examples of the computer readable storage medium includes each of the following (and appropriate combinations): flexible disk, hard disk, solid-state drive (SSD), random access memory (RAM), read-only memory (ROM), erasable programmable read-only memory (EPROM or Flash), static random access memory (SRAM), compact disc (CD or CD-ROM), digital versatile disk (DVD) and memory card or stick. A computer readable storage medium, as used in this disclosure, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described in this disclosure can be downloaded to an appropriate computing or processing device from a computer readable storage medium or to an external computer or external storage device via a global network (i.e., the Internet), a local area network, a wide area network and/or a wireless network. The network may include copper transmission wires, optical communication fibers, wireless transmission, routers, firewalls, switches, gateway computers and/or edge servers. A network adapter card or network interface in each computing or processing device may receive computer readable program instructions from the network and forward the computer readable program instructions for storage in a computer readable storage medium within the computing or processing device.

Computer readable program instructions for carrying out operations of the present disclosure may include machine language instructions and/or microcode, which may be compiled or interpreted from source code written in any combination of one or more programming languages, including assembly language, Basic, Fortran, Java, Python, R, C, C++, C# or similar programming languages. The computer readable program instructions may execute entirely on a user's personal computer, notebook computer, tablet, or smartphone, entirely on a remote computer or computer server, or any combination of these computing devices. The remote computer or computer server may be connected to the user's device or devices through a computer network, including a local area network or a wide area network, or a global network (i.e., the Internet). In some embodiments, electronic circuitry including, for example, programmable logic circuitry, field-programmable gate arrays (FPGA), or programmable logic arrays (PLA) may execute the computer readable program instructions by using information from the computer readable program instructions to configure or customize the electronic circuitry, in order to perform aspects of the present disclosure.

Aspects of the present disclosure are described herein with reference to flow diagrams and block diagrams of methods, apparatus (systems), and computer program products according to embodiments of the disclosure. It will be understood by those skilled in the art that each block of the flow diagrams and block diagrams, and combinations of blocks in the flow diagrams and block diagrams, can be implemented by computer readable program instructions.

The computer readable program instructions that may implement the systems and methods described in this disclosure may be provided to one or more processors (and/or one or more cores within a processor) of a general purpose computer, special purpose computer, or other programmable apparatus to produce a machine, such that the instructions, which execute via the processor of the computer or other programmable apparatus, create a system for implementing the functions specified in the flow diagrams and block diagrams in the present disclosure. These computer readable program instructions may also be stored in a computer readable storage medium that can direct a computer, a programmable apparatus, and/or other devices to function in a particular manner, such that the computer readable storage medium having stored instructions is an article of manufacture including instructions which implement aspects of the functions specified in the flow diagrams and block diagrams in the present disclosure.

The computer readable program instructions may also be loaded onto a computer, other programmable apparatus, or other device to cause a series of operational steps to be performed on the computer, other programmable apparatus or other device to produce a computer implemented process, such that the instructions which execute on the computer, other programmable apparatus, or other device implement the functions specified in the flow diagrams and block diagrams in the present disclosure.

FIG. 7 is a functional block diagram illustrating a networked system 800 of one or more networked computers and servers. In an embodiment, the hardware and software environment illustrated in FIG. 7 may provide an exemplary platform for implementation of the software and/or methods according to the present disclosure.

Referring to FIG. 7, a networked system 800 may include, but is not limited to, computer 805, network 810, remote computer 815, web server 820, cloud storage server 825 and computer server 830. In some embodiments, multiple instances of one or more of the functional blocks illustrated in FIG. 7 may be employed.

Additional detail of computer 805 is shown in FIG. 7. The functional blocks illustrated within computer 805 are provided only to establish exemplary functionality and are not intended to be exhaustive. And while details are not provided for remote computer 815, web server 820, cloud storage server 825 and computer server 830, these other computers and devices may include similar functionality to that shown for computer 805.

Computer 805 may be a personal computer (PC), a desktop computer, laptop computer, tablet computer, netbook computer, a personal digital assistant (PDA), a smart phone, or any other programmable electronic device capable of communicating with other devices on network 810.

Computer 805 may include processor 835, bus 837, memory 840, non-volatile storage 845, network interface 850, peripheral interface 855 and display interface 865. Each of these functions may be implemented, in some embodiments, as individual electronic subsystems (integrated circuit chip or combination of chips and associated devices), or, in other embodiments, some combination of functions may be implemented on a single chip (sometimes called a system on chip or SoC).

Processor 835 may be one or more single or multi-chip GPUs, CPUs, or microprocessors, such as those designed and/or manufactured by Intel Corporation, Advanced Micro Devices, Inc. (AMD), Arm Holdings (Arm), Apple Computer, etc. Examples of microprocessors include Celeron, Pentium, Core i3, Core i5 and Core i7 from Intel Corporation; Opteron, Phenom, Athlon, Turion and Ryzen from AMD; and Cortex-A, Cortex-R and Cortex-M from Arm.

Bus 837 may be a proprietary or industry standard high-speed parallel or serial peripheral interconnect bus, such as ISA, PCI, PCI Express (PCI-e), AGP, and the like.

Memory 840 and non-volatile storage 845 may be computer-readable storage media. Memory 840 may include any suitable volatile storage devices such as Dynamic Random Access Memory (DRAM) and Static Random Access Memory (SRAM). Non-volatile storage 845 may include one or more of the following: flexible disk, hard disk, solid-state drive (SSD), read-only memory (ROM), erasable programmable read-only memory (EPROM or Flash), compact disc (CD or CD-ROM), digital versatile disk (DVD) and memory card or stick.

Program 848 may be a collection of machine readable instructions and/or data that is stored in non-volatile storage 845 and is used to create, manage and control certain software functions that are discussed in detail elsewhere in the present disclosure and illustrated in the drawings. In some embodiments, memory 840 may be considerably faster than non-volatile storage 845. In such embodiments, program 848 may be transferred from non-volatile storage 845 to memory 840 prior to execution by processor 835.

Computer 805 may be capable of communicating and interacting with other computers via network 810 through network interface 850. Network 810 may be, for example, a local area network (LAN), a wide area network (WAN) such as the Internet, or a combination of the two, and may include wired, wireless, or fiber optic connections. In general, network 810 can be any combination of connections and protocols that support communications between two or more computers and related devices.

Peripheral interface 855 may allow for input and output of data with other devices that may be connected locally with computer 805. For example, peripheral interface 855 may provide a connection to external devices 860. External devices 860 may include devices such as a keyboard, a mouse, a keypad, a touch screen, and/or other suitable input devices. External devices 860 may also include portable computer-readable storage media such as, for example, thumb drives, portable optical or magnetic disks, and memory cards. Software and data used to practice embodiments of the present disclosure, for example, program 848, may be stored on such portable computer-readable storage media. In such embodiments, software may be loaded onto non-volatile storage 845 or, alternatively, directly into memory 840 via peripheral interface 855. Peripheral interface 855 may use an industry standard connection, such as RS-232 or Universal Serial Bus (USB), to connect with external devices 860. An example of an external device 860 is a radio frequency (RF) device that conveys RF messages of travel road data or obstacle data.

Display interface 865 may connect computer 805 to display 870. Display 870 may be used, in some embodiments, to present a command line or graphical user interface to a user of computer 805. Display interface 865 may connect to display 870 using one or more proprietary or industry standard connections, such as VGA, DVI, DisplayPort and HDMI.

As described above, network interface 850, provides for communications with other computing and storage systems or devices external to computer 805. Software programs and data discussed herein may be downloaded from, for example, remote computer 815, web server 820, cloud storage server 825 and computer server 830 to non-volatile storage 845 through network interface 850 and network 810. Furthermore, the systems and methods described in this disclosure may be executed by one or more computers connected to computer 805 through network interface 850 and network 810. For example, in some embodiments the systems and methods described in this disclosure may be executed by remote computer 815, computer server 830, or a combination of the interconnected computers on network 810.

Data, datasets and/or databases employed in embodiments of the systems and methods described in this disclosure may be stored and or downloaded from remote computer 815, web server 820, cloud storage server 825 and computer server 830.

The embodiment of the present disclosure has been described above with reference to specific examples. However, the present disclosure is not limited to these specific examples. This means that the present disclosure implemented by a person skilled in the art by making design changes as appropriate to these specific examples is also included in the scope of the present disclosure, as long as the features of the disclosure are retained.

What is claimed is:

1. A vehicle driving support system comprising:
circuitry configured to
acquire travel road information relating to a travel road;
acquire obstacle information relating to an obstacle on the travel road;
set a plurality of candidate paths on the travel road based on the travel road information;
set, within a first predetermined distance of the obstacle, a warning area with an outer shape according to the obstacle;
set a plurality of sampling points at predetermined intervals along each of the plurality of candidate paths, wherein the sampling points are set at first intervals along a part of the candidate path that is included in the warning area, and are set at second intervals, longer than the first intervals, along other parts of the candidate path;
calculate a path cost at each of the plurality of sampling points;
select one of the plurality of candidate paths as the target path based on the path cost; and
control the vehicle so as to travel along the target path.

2. The vehicle driving support system of claim 1, wherein
the circuitry is configured to set a size of the warning area as a function of a distance from the vehicle to the obstacle.

3. The vehicle driving support system of claim 1, wherein
the circuitry is configured to set the warning area to be a first size when the vehicle is a first distance from the obstacle and set the warning area to be a second size, which is larger than the first size, when the vehicle is a second distance from the obstacle, the second distance being greater than the first distance.

4. The vehicle driving support system of claim 1, wherein
the circuitry is configured to set the outer shape of the warning area larger when the obstacle is a vehicle than when the obstacle is a pedestrian.

5. The vehicle driving support system of claim 1, wherein
the circuitry is configured to set the first interval shorter when the obstacle is a pedestrian than when the obstacle is a vehicle.

6. The vehicle driving support system of claim 1, wherein
the circuitry is configured to, when there are a plurality of obstacles on the travel road, set the warning area for an obstacle that is closest to the vehicle and set no warning area for the other obstacles.

7. The vehicle driving support system of claim 1, wherein
the circuitry is configured to set only sampling points that are in the warning area at the first intervals.

8. The vehicle driving support system of claim 1, wherein
the circuitry is configured to set the sampling points at the first intervals along a part of the candidate path that is within a second predetermined distance of the vehicle in a travel direction of the vehicle.

9. The vehicle driving support system of claim 8, wherein
the circuitry is configured to set the sampling points, which are located between the second predetermined distance and the warning area, at the second intervals.

10. The vehicle driving support system of claim 8, wherein
the circuitry is configured set the second predetermined distance as a function of a moving speed of the vehicle.

11. The vehicle driving support system of claim 8, wherein
the circuitry is configured to set the second predetermined distance to be a first distance when the moving speed of the vehicle is a first speed and set the second predetermined distance to be a second distance, which is greater than the first distance, when the moving speed is a second speed, which is greater than the first speed

12. The vehicle driving support system of claim 1, wherein
the circuitry is configured to set an amount of control for speed control and/or steering control of the vehicle at each of the plurality of sampling points.

13. The vehicle driving support system of claim 1, further comprising:
a set of sensors including at least one of a camera, a radar and a Lidar, wherein
the circuitry is configured to obtain the obstacle information from the set of sensors.

14. The vehicle driving support system of claim 1, further comprising:
a wireless communication interface, wherein
the circuitry is configured to receive the travel road information via the wireless communication interface.

15. A method performed by a vehicle driving support system, the method comprising:
acquiring travel road information relating to a travel road;
acquiring obstacle information relating to an obstacle on the travel road;
setting a plurality of candidate paths on the travel road based on the travel road information;
setting, within a first predetermined distance of the obstacle, a warning area with an outer shape according to the obstacle;
setting a plurality of sampling points at predetermined intervals along each of the plurality of candidate paths, wherein the sampling points are set at first intervals along a part of the candidate path that is included in the warning area, and are set at second intervals, longer than the first intervals, along other parts of the candidate path;
calculating a path cost at each of the plurality of sampling points;
selecting one of the plurality of candidate paths as the target path based on the path cost; and
controlling the vehicle so as to travel along the target path.

16. The method of claim 15, further comprising:
setting a size of the warning area as a function of a distance from the vehicle to the obstacle.

17. The vehicle driving support system of claim 15, further comprising:
setting the warning area to be a first size when the vehicle is a first distance from the obstacle and setting the warning area to be a second size, which is larger than the first size, when the vehicle is a second distance from the obstacle, the second distance being greater than the first distance.

18. The method of claim 15, further comprising:
setting the outer shape of the warning area larger when the obstacle is a vehicle than when the obstacle is a pedestrian.

19. The method of claim 15, further comprising:
setting the first interval shorter when the obstacle is a pedestrian than when the obstacle is a vehicle.

20. A non-transitory computer-readable medium including computer program instructions, which when executed by a processor, cause the processor to:
acquire travel road information relating to a travel road;
acquire obstacle information relating to an obstacle on the travel road;
set a plurality of candidate paths on the travel road based on the travel road information;
set, within a first predetermined distance of the obstacle, a warning area with an outer shape according to the obstacle;
set a plurality of sampling points at predetermined intervals along each of the plurality of candidate paths, wherein the sampling points are set at first intervals along a part of the candidate path that is included in the warning area, and are set at second intervals, longer than the first intervals, along other parts of the candidate path;
calculate a path cost at each of the plurality of sampling points;
select one of the plurality of candidate paths as the target path based on the path cost; and
control the vehicle so as to travel along the target path.
